(19) United States
(12) Patent Application Publication
(10) Pub. No.: US 2010/0171302 A1
(43) Pub. Date: Jul. 8, 2010

(54) PUSH-TWIST CONNECTOR

(75) Inventor: Keith W. Yoder, Goshen, IN (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: NIBCO Inc., Elkhart, IN (US)

(21) Appl. No.: 12/348,472

(22) Filed: Jan. 5, 2009

(51) Int. Cl. F16L 55/00

(52) U.S. Cl. 285/81

(57) ABSTRACT

A push-in plumbing connector includes a ring seal, a backing member, a threaded seal compression member, and a locking ring insert which moves between a locked and unlocked position for the insertion and locking of a pipe within the connector. The connector cooperates with a threaded socket of a plumbing fitting having a tapered side wall for engaging the seal which surrounds a pipe inserted into the connector.

### BACKGROUND OF THE INVENTION

The present invention relates to a plumbing connection for sealably coupling two plumbing elements and particularly to a push-to-connect fitting.

There have been several proposals for coupling pipe tubing, such as in a water distribution system, which eliminates the need for soldering copper pipe joints but which still may use copper or other materials, such as polyethylene, for the conducting of fluids. Typically, a fitting can be either a straight junction, an elbow of varying degrees and size, a valve or other plumbing fitting for connecting to a pipe or tube. In the past, push-type connectors have employed a socket for receiving a sealing member, such as an O-ring, a locking ring, which fits within the socket and which includes tines which engage and grip a pipe which is fitted therein. Such connectors also use some form of locking/unlocking member which can be employed for releasably engaging the locking ring, such that the pipe can be disconnected, if desired, from the socket. Although such systems provide the desirable quick push-to-connect feature, which allows relatively quick assembly of a plumbing system utilizing multiple push-to-connect fittings, they are somewhat prone to leakage, in part, due to the damaging of the O-rings by the burred end of a pipe being inserted into the connector or the under compression of the O-ring.

Thus, there exists a need for an improved push-to-connect fitting which provides the advantages of a rapidly assembled plumbing connection but which provides assurances that the connection remains watertight over the lifetime of the system.

### SUMMARY OF THE INVENTION

This invention provides a push-in plumbing coupling for sealing a pipe to a threaded socket of a fitting which includes an annular seal and a threaded compression member having a surface for engaging the seal. The compression member includes a tapered bore for receiving a pipe and a locking member and a generally cylindrical locking member including a plurality of flexible arcuate arms with pipe-engaging locking edges. The locking member extends within the threaded compression member and is axially movable with respect to the threaded compression member between a pipe locking and releasing position.

The system of the present invention provides such advantages by providing a connector having a socket for receiving a sealing ring seal, a backing member, a threaded seal compression member, and a locking ring insert which moves between a locked and unlocked position for locking a pipe within the connector. In a preferred embodiment of the invention, the coupling includes a female threaded socket having an O-ring seat with a tapered side wall, and the O-ring backing member has a tapered side wall mating with the socket. The threaded compression member engages the O-ring backing member for compressing the O-ring against the pipe once inserted into the fitting. The threaded compression member includes an internally tapered bore which receives a locking member having flexible arcuate fingers with gripping elements near one end thereof, such that the axial movement of the locking member within the tapered bore of the threaded securing member selectively locks and grips a pipe inserted therein upon installation and can be moved to a releasing position for removal of a pipe from the push-to-connect fitting.

Such a system allows the desirable push-to-connect quick assembly and additionally assures that the seal is adequately compressed against the inserted pipe to form a long lasting, watertight connection. By providing an additional threaded member for compressing the O-ring independently of the locking member, an extremely reliable seal can be achieved. If necessary, the threaded compression member can be tightened over time to eliminate any leak which might develop. The system can employ molded polymeric components for providing a reliable, reduced cost coupling.

These and other features, objects and advantages of the present invention will become apparent upon reading the following description thereof together with reference to the accompanying drawings.

### BRIEF DESCRIPTION OF THE DRAWINGS

FIG. 1 is a perspective view of a plumbing connection incorporating the components of the present invention;

FIG. 2 is an exploded vertical cross-sectional view of the fitting shown in FIG. 1;

FIG. 3 is an enlarged cross-sectional view of the encircled area III of FIG. 2;

FIG. 4 is a cross-sectional view of the fitting of the present invention shown with a tube inserted therein prior to sealing;

FIG. 5 is an enlarged view of the encircled area V of FIG. 4;

FIG. 6 is a vertical cross-sectional view of the fitting show in FIG. 4, shown in a pipe locked and sealed position;

FIG. 7 is an enlarged view of the encircled area VII of FIG. 6;

FIG. 8 is a perspective view of an elbow coupling embodying the push-twist connectors of the present invention at each end;

FIG. 9 is a cross-sectional view of the structure of FIG. 8 taken along section line IX-IX of FIG. 8; and

FIG. 10 is a cross-sectional view like FIG. 9 but using a polymeric elbow instead of a metal elbow.

### DETAILED DESCRIPTION OF THE PREFERRED EMBODIMENT

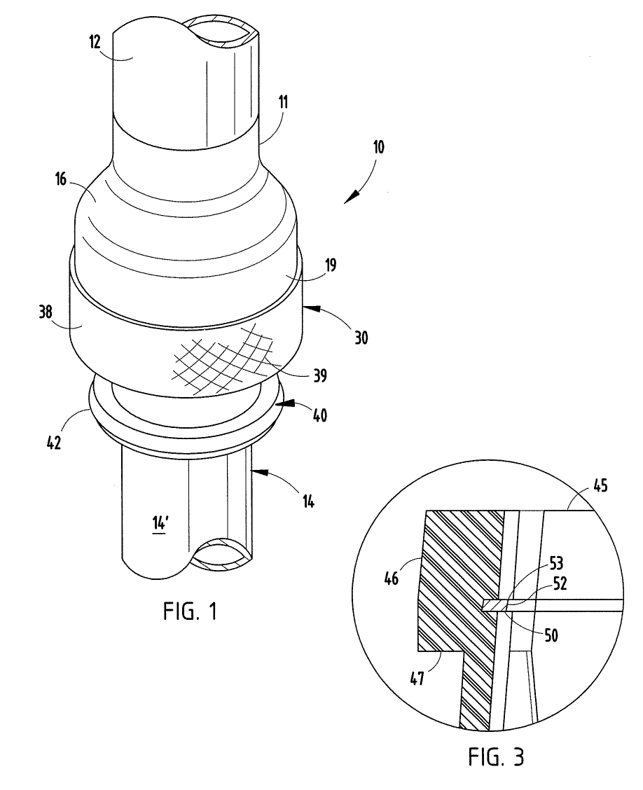

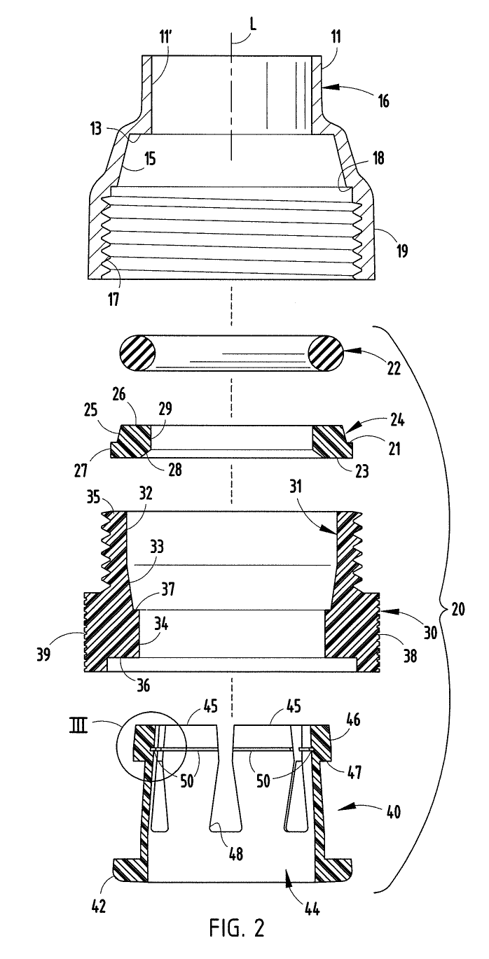

Referring initially to FIG. 1, there is shown a plumbing coupling 10 for sealably coupling a first pipe or fitting 12 to a second pipe 14. The coupling 10 includes the improved push-to-connect fitting 20 (FIG. 2) of the present invention, which cooperates with a threaded female socket 16 coupled to a fitting by means of mechanical joinery, thereby resulting in a fitting in which socket 16 is integral to the fitting, such as an elbow 100 shown in FIG. 8, a T-fitting, a valve, or any other pipe fitting to be joined to another pipe, such as pipe 14. Socket 16 can also be a polymeric material, as shown by socket 16 integral with elbow 200 shown in FIG. 10. Thus, although the coupling 10 is illustrated showing the coupling of two pipes 12 and 14, the socket 16 can be formed or coupled to any metallic or polymeric plumbing fitting, such as elbows, tees, valves, or the like. The system of the present invention is uniquely adapted for use in connection with metallic piping, such as copper, but can be employed with polymeric piping in a plumbing system.

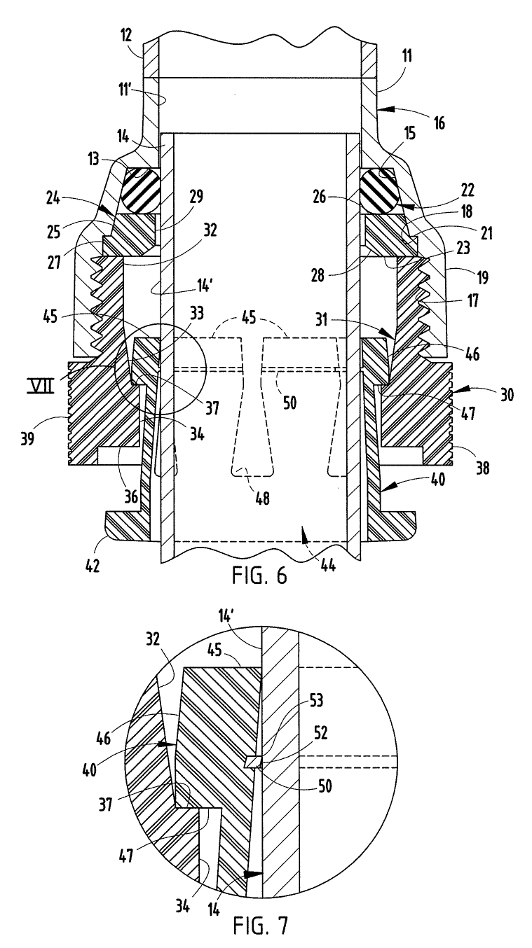

Socket 16 is shown in detail in FIG. 2 and includes an end 11 with a circular bore 11 for coupling to a pipe 12 or to a plumbing fitting by soldering, welding, brazing or other conventional means. The socket 16 includes a tapered side wall 15 and a first annular seat 13 extending orthogonal to the longitudinal axis L of the fitting. Side wall 15 extends outwardly and downwardly (as seen in FIG. 2) to a second annular seat 18 and an internally threaded section 17 in the enlarged end 19 of socket 16. The fitting 20 of the present invention cooperates with socket 16 to sealably connect pipe 14 to pipe 12, as seen and described below in connection with FIG. 6.

The fitting 20 of the present invention includes several components, including seal 22, preferably an O-ring seal made of a suitable elastomeric material typically employed for O-rings, an annular backing member 24 having an O-ring engaging annular surface 26, a tapered side wall 25 which engages wall 15 of socket 16 as shown in conjunction with FIG. 6 below, and an enlarged annular flange 27 providing an engaging surface for threaded compression member 30 of fitting 20. The backing member 24 also includes an inwardly tapered entry surface 28 communicating with the central bore 29 to facilitate the insertion of pipe 14 within the bore 29 and O-ring 22. Annular surface 23 of member 24 is engaged by surface 35 of compression member 30 as discussed below.

The threaded compression member 30 includes a configured bore 31 having an upper section 32 which is substantially cylindrical, an intermediate section 33 which is tapered inwardly to an annular seat 37. A lower cylindrical section 34 communicates with a larger diameter annular recess 36 terminating the end of the head 38 of member 30. The outer surface is knurled at 39 for hand tightening the threaded compression member within socket 16 as described below.

The threaded compression member receives the locking member 40, also seen in FIG. 2, which is generally a cylindrical collar having an outer flange 42, a central bore 44, and a plurality of spaced-apart arcuate flexible arms 45, each having an outwardly extending locking flange 46 at the ends thereof. The locking flanges 46 include segmented arcuate annular ledges 47 for engaging the annular seat 37 of the threaded compression member as described below. Molded and, therefore, mounted within each of the six (6) flexible arms 45 in the preferred embodiment in spaced relationship to their tips is a metal locking insert 50 which, as best seen in FIG. 3, includes a tapered edge 52 with an outwardly extending tip 53 which digs into the outer side wall 14′ of pipe 14 once inserted therein when locking member 40 is in a locking position with arms 45 pushed against the pipe 14. The arms 45 are narrowed at their end 48 joining the body of locking member 40, as best seen in FIG. 2. This improves the flexibility of the arms for moving into a locking or unlocking position.

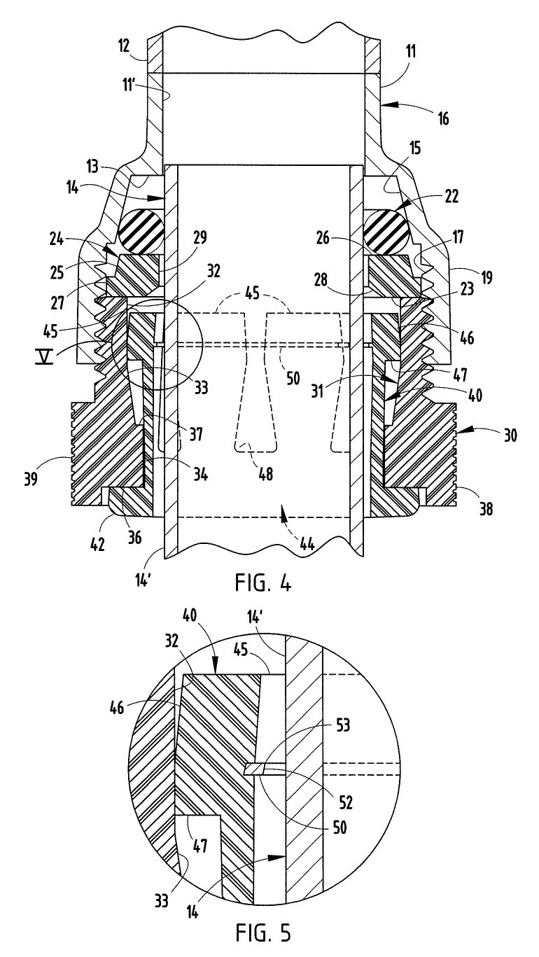

The installation of pipe 14 into coupling 10 is illustrated in FIGS. 4 and 5 in which the locking member 40 with its flexible arms 45 is positioned within the threaded securing member 30 with end flanges 46 of locking member 40 positioned in the enlarged cylindrical side wall 32 of threaded compression member 30. This allows the arms 45 to expand outwardly and allow the pipe 14 to pass through locking member 40 through backing member 24 guided by tapered surface 28 and through the uncompressed O-ring 22, which is within the tapered side wall 15 of socket 16 upon the initial insertion of the pipe 14.

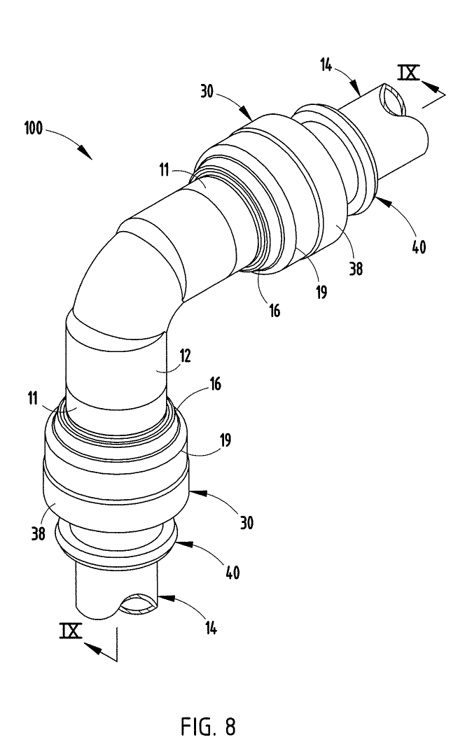

FIG. 5 shows the relative relationship of the arms 45 and side wall 32, the locking member 40, and threaded compression member 30, respectively. In this position, the flange 42 of locking member 40 is seated within the annular recess 36 of threaded securing member 30 (i.e., pushed inwardly) to a pipe releasing (or inserting) position. Pipe 14 is pushed inwardly a distance to clear the O-ring seal 22, which can be measured from length of the fitting until it abuts a stop in 16 or a rim of a standard pipe fitting, which has been previously secured to socket 16, as seen in FIGS. 8-10. In the inserted position shown in FIGS. 4 and 5, the O-ring 22 is uncompressed and is positioned at the lower end of the tapered surface 15 of socket 16. For the completion of the sealed connection as seen in FIGS. 6 and 7, first the threaded securing member 30 is rotated in a clockwise direction to enter the threaded section 17 of socket 16 until surface 26 of backing member 24 engages O-ring 22 and compresses the O-ring against the O-ring tapered seating surface 15 of socket 16 compressing the O-ring between surface 26 of backing member 24 and surface 15 of socket 16 and against the outer cylindrical surface 14′ of pipe 14. In this position, the tapered lower end 33 of threaded compression member 30 engages the outer surfaces 46 of arms 45 of locking member 40, pushing them inwardly against surface 14′. The tips 53 of locking inserts 50 dig into the surface 14′ of pipe 14, as best seen in FIGS. 6 and 7, to prevent withdrawal of pipe 14 from the plumbing connection 10 so formed.

The threaded compression member is shown in its fully seated position with annular shoulder 21 of backing member 24 seated against annular seat 18 of socket 16. In this position, O-ring 22 is properly compressed against seating surface 15 and O-ring seat 13 of socket 16 and is sealed to the outer surface 14′ of pipe or conduit 14. As compression member 30 is threaded into socket 16, it engages surfaces 46 of member 40 to urge arms 45 and locking inserts 50 therein into the position shown in FIG. 6 for gripping and holding pipe 14 in place.

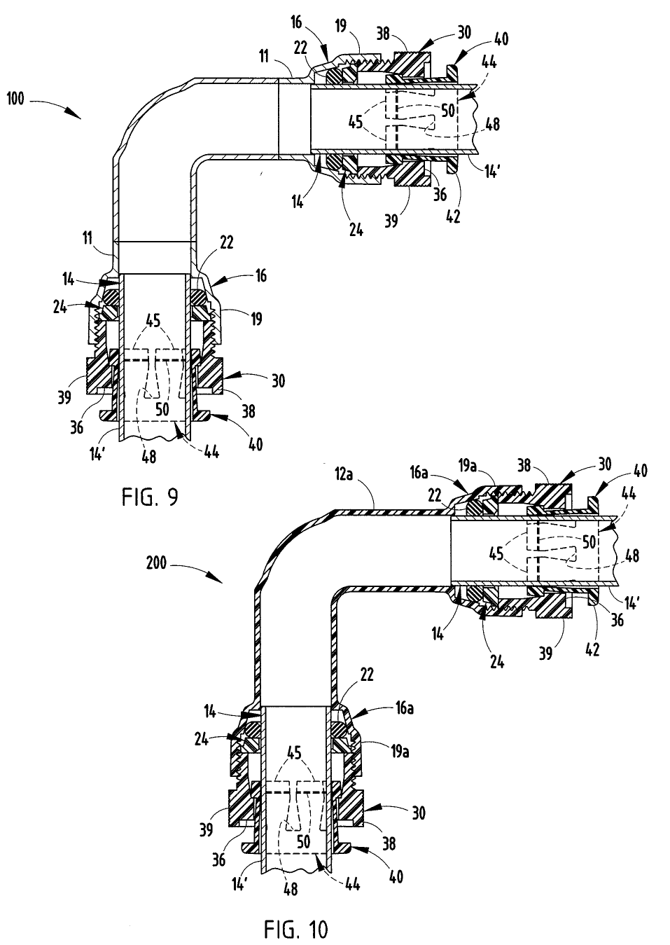

The connector shown in FIGS. 1-7 is typically included in a pipe fitting, such as an elbow 100 shown in FIGS. 8 and 9, in which the socket 16 is integrally formed and welded to the right angle elbow 12 shown and includes such a connector 20 (FIG. 2) including elements 30 and 40 at each end of the fitting 100. The corresponding elements of the connector are numbered the same as shown in FIGS. 1-7. In some embodiments, the fitting will be a polymeric fitting, such as fitting 200 shown in FIG. 10, in which case the socket 16 will be integrally molded and formed with the elbow 12a as a single piece and receive the coupling assembly 20, such as shown in FIG. 2, at each end for coupling pipes, such as pipe 14′, to each end of the fitting. Elbow fittings 100 and 200, shown in FIGS. 8-10, are illustrative only of one type of pipe fitting which can benefit from the push-twist connector of the present invention, which has equal applicability to other angled elbows, straight couplings, tees, valves, and any other type of plumbing fitting which may be employed in a plumbing installation.

The system of the present invention, thus, provides a unique structure which assures both the push-in connection of a pipe within a fitting to prevent removal but allow removal when desired and a unique compression seal assembly which assures a seal is properly made between the two pipes or other plumbing fitting being connected.

It will become apparent to those skilled in the art that various modifications to the preferred embodiment of the invention as described herein can be made without departing from the spirit or scope of the invention as defined by the appended claims.

The invention claimed is:

1. A push-in plumbing connector for providing a fluid tight connection between a conduit and a threaded socket of a fitting comprising:
an annular seal;
a generally annular backing member having an annular surface engaging said seal;
a threaded compression member having a surface for engaging said backing member and having a tapered bore for receiving a pipe and a locking member; and
a generally cylindrical locking member including a plurality of flexible arcuate arms with pipe-engaging locking edges, said locking member extending within said threaded compression member and axially movable with respect to said threaded compression member between a pipe locking and releasing position.

2. The connector as defined in claim 1 wherein said bore of said compression member is inwardly tapered such that as said compression member is threaded into the socket of a fitting it urges said arms of said locking member radially inwardly

3. The connector as defined in claim 2 wherein said compression member includes an annular surface engaging said backing member.

4. The connector as defined in claim 3 wherein said backing member includes a tapered entry to said bore of said backing member.

5. The connector as defined in claim 4 wherein said compression member includes a annular ledge which cooperates with said locking member to retain said locking member within said compression member once assembled.

6. The connector as defined in claim 5 wherein said arms of said locking member are tapered to increase their flexibility.

7. The connector as defined in claim 6 wherein said locking member is molded of a polymeric material and said edges are formed of metal inserts.

8. The connector as defined in claim 7 wherein said inserts include a tapered surface defining a tip for engaging the outer surface of a pipe.

9. A plumbing fitting with a connector comprising:
a plumbing fitting selected from the group of an elbow, a tee, a coupling, and a valve and including at least one connector including a socket having a tapered bore and a threaded end communicating with said tapered bore, said tapered bore defining a seal-receiving surface and terminating in a first annular seat;
a seal positioned within said socket to engage said seal-receiving surface;
a generally cylindrical locking member including a plurality of flexible spaced-apart arcuate arms with pipe-engaging tips; and
a compression member threadably coupled to said socket and axially movable with respect to said socket to compress said seal and engage said arms of said locking member to move said arms in a radial direction to a pipe locking position, and wherein said socket includes a second annular seat axially spaced from said first annular seat.

10. The fitting as defined in claim 9 wherein said locking member is molded of a polymeric material and said arms include metal inserts near ends thereof for gripping a pipe inserted into said connector.

11. The fitting as defined in claim 10 wherein said inserts include a tapered surface defining a tip for engaging the outer surface of a pipe.

12. The fitting as defined in claim 9 and further including a generally annular backing member positioned between said seal and said compression member, said backing member having an annular surface for engaging said seal and an annular shoulder for engaging said second annular seat of said socket.

13. The fitting as defined in claim 12 wherein said backing member includes a tapered entry on a side opposite said seal.

14. The fitting as defined in claim 13 wherein said compression member includes a annular ledge which cooperates with said locking member to retain said locking member within said compression member once assembled.

15. The fitting as defined in claim 14 wherein said arms of said locking member are tapered to increase their flexibility.

16. A push-in plumbing coupling comprising:
a plumbing fitting including a socket having a tapered bore and a threaded end communicating with said tapered bore, said tapered bore having a seal-receiving surface and an annular seat;
an annular seal;
a generally annular backing member having an annular surface engaging said seal, a tapered surface mating with said tapered bore of said socket and a tapered entry for receiving a pipe therein;
a threaded compression member having an annular surface for engaging said backing member and having a tapered bore for receiving a pipe and a locking member; and
a generally cylindrical locking member including a plurality of flexible arcuate arms with pipe-engaging locking edges, said locking member extending within said threaded compression member and axially movable with respect to said threaded compression member between a pipe locking and releasing position.

17. The coupling as defined in claim 16 wherein said tapered bore of said compression member urges said arms of said locking member radially inwardly toward a pipe inserted into said coupling as said compression member is threaded into said socket.

18. The coupling as defined in claim 17 wherein said locking member is molded of a polymeric material and said arms include metal inserts near ends thereof for gripping a pipe inserted into said coupling.

19. The coupling as defined in claim 18 wherein said inserts include a tapered surface defining a tip for engaging the outer surface of a pipe.

20. The coupling as defined in claim 19 wherein said arms of said locking member are tapered to increase their flexibility.
